(19) United States
(12) Patent Application Publication
(10) Pub. No.: US 2025/0047716 A1
(43) Pub. Date: Feb. 6, 2025

(54) SYSTEMS AND METHODS FOR ACTIVE DENIAL SECURITY SYSTEMS

(71) Applicant: MYTI, Inc., Delray Beach, FL (US)

(72) Inventors: Steven W. Goldstein, Delray Beach, FL (US); Eric Browy, Meridian, ID (US)

(73) Assignee: MYTI, Inc., Delray Beach, FL (US)

(21) Appl. No.: 18/792,195

(22) Filed: Aug. 1, 2024

Related U.S. Application Data
(60) Provisional application No. 63/530,152, filed on Aug. 1, 2023.

(51) Int. Cl. H04L 9/40

(52) U.S. Cl. CPC H04L 63/20; H04L 63/107

(57) ABSTRACT

A method that includes (a) receiving a request to authenticate a user of an active denial management system, (b) generating a scan result of a security facility after the request, wherein the scan result includes a representation of a set of activities at a location of the security facility, (c) applying a machine learning model to the scan result such that the machine learning model determines whether the result includes at least one activity of the set of activities that is prohibited by a security policy set before the request is received, (d) performing based on the security policy and the at least one activity, an authorization of an activation of a deterrent control system expected to deter the at least one activity, (e) generating the authorization of the activation of the deterrent control system for the user, and (f) taking an action based on the authorization.

### REFERENCE TO RELATED PATENT APPLICATION

The present application claims benefit of U.S. Provisional Application No. 63/530,152, filed on Aug. 1, 2023. The content of the above document is incorporated herein by reference in its entirety.

### TECHNICAL FIELD

The disclosure is meant to be used in the physical security field, implementing elements from Machine Learning, Spatial Mapping, 3D Rendering, Security Cameras and Systems, Distributed Computation, Edge Processing, UAS, lethal, Non-Lethal and less than lethal technologies, Motion Control, and Computer Vision.

### BACKGROUND

In the previous embodiments of security systems there have been many versions of observing a scenario, this includes on-premises security centers where the area is observed. This was a model for physical security for a long period of time. The next evolution of physical security included a migration to the cloud computing environment which enabled remote monitoring of a video management system. All of these systems were similar in nature, e.g., they were platforms which could observe but not repel personnel without security force engagement. Within this disclosure a system with the next level of intervention is disclosed.

### SUMMARY

In the current social and political climate, it is desired to create technologies that can assist or aid in Law Enforcement, Physical Security personal, and parallel fields to deescalate the threat and reduce the potential of fatal injury to both the security personal as well as the interloper. With the modern advent of integrated systems including high-speed low-cost compute mixed with machine learning and artificial intelligence, there is a desire to create a system which actively denies people from conducting unlawful behaviors or entering restricted areas using countermeasure and interdiction technologies. To safely interdict and deter an interloper there may be a variety of underlying infrastructures which will be described in this disclosure.

There is a desire to have certain underlying subsystems that integrate computing functions across technical boundaries by applying machine learning, computer vision, artificial intelligence, 3D mapping and rendering, non-lethal and less than lethal countermeasure technology, motion control, distributed computation, and/or edge processing, or any combination thereof. As part of the integrated system, there is a desire to perform in accordance with an Open Network Video Interface Forum (ONVIF) protocol and the Physical Security Interoperability Alliance (PSIA), which is widely used for the control and operation of intelligent sensors and/or other industry standards in the realm of physical security to create a single visual presentation (e.g., a site picture) which an operator can use to control different assets both mobile and fixed to interdict an interloper attempting to enter an unauthorized area. ONVIF and the PSIA provide forums for developing a standard for the interface of internet protocol (IP)—based security products.

The present disclosure describes various embodiments of an active denial system, where these embodiments enable a creation of various systems, devices and methods to prevent, reduce, or minimize people from conducting negative behavior while deescalating the situation. Within this disclosure, there are various systems outlined in various embodiments which may be used alone or as part of other embodiments to prevent, reduce, or minimize negative behavior, as further explained below. For some use cases, an active denial system may be defined as one which implements a variety of tools (e.g., hardware, software) to effectuate, enable or cause a change in the behavior of an individual engaged in unauthorized or unlawful access as defined by laws or policies at that time.

The methods for this behavior change can include but are not limited to non-lethal and less than lethal technologie, including direct energy, chemical, kinetic deterrents which interact with the senses of humans to effectuate, enable or cause a flight response. An example deterrent may be an acoustic system which emits a sound having a range of frequencies from 50 Hz-20,000 Hz. A human exposed to the emitted sound will startle or adjust behavior due to a para-sympathetic fight or flight response. Another embodiment of a deterrent may be a system which implements a spatial light modulation of a red, green, blue, and/or other wavelength lasers to obscure visual perception of the human.

In the security profession there is a common theme of Unmanned Arial Systems (UAS) penetrating a perimeter of facilities or protected assets and a Counter-UAS system (C-UAS) which challenges the UAS. The system within the disclosure focuses on deterring and denying human access rather than UAS, which can be referred to as a Counter Personnel Systems (CPS).

These CPS installations may be made of many conceptual layers. In particular, the base layer of a CPS is the infrastructure currently powering the facility, such as the power supply, network, water supply, waste management, building and facilities, and others. The next layer builds on the base infrastructure and includes all the sensing elements in the infrastructure, such as temperature sensors, light sensors, power measurement systems, emergency medical automated systems, and access control systems. The next layer is the computation layer which is a key element in the distribution of computation as needed by latency and urgency requirements by the nuclear power facility. Following this layer is the digital twin layer having a computational model of a building or facility to include 3D mapping of the entire workspace. On top of this layer, there is infrastructure machine learning and analytics, an embodiment of which is an algorithm which measures human traffic in a particular area and adjusts the HVAC system as a function of this measurement. Since for an area, such as but not limited to a nuclear facility, there are standard operating procedures and rules of engagement that must be followed, this system enables a method to create a policy engine (e.g., a task-dedicated executable logic that can be started, stopped, or paused) which sets guidelines in the software when used, as disclosed herein. This configuration limits specific actions to areas unless manually overridden by a security professional with the correct roles-based authentication as permission.

The following layer of the CPS is the active layer for security professionals who monitor environments of a system, and this is accomplished, in one embodiment, with a User Interface which includes the digital twin and live security feeds and outputs currently implemented by one skilled in the art in some use cases. Some embodiments of this system may be tracking all sensed people and physical assets within the declared area and updating a 3D virtual model to show the position of these elements localized into a priori map of the area of interest. In this model, some mobile assets may be visible and these mobile assets can include but are not limited to Unmanned Aerial Systems, Unmanned Ground Systems, and other vehicles, whether land, aerial, or marine. These mobile platforms compose the next hierarchical slice of the technology stack. The mobile platforms have multiple purposes one of which is to extend the efficacy and efficiency of the deterrents. The deterrents, such as those with acoustic emissions (e.g., sounds) and photonic emissions (e.g., visible and non-visible laser light) may be used by the CPS, deterring that behavior which is unwanted or unlawful. The installed Counter Personnel Systems and mobile platforms are in a feedback loop with the ambient scene. The CPS may determine that a detected behavior is unauthorized or unlawful by using classical, machine learning, artificial intelligence, and deep learning. These algorithms measure various outputs, and in one embodiment, these outputs may include measurement and analysis by computer vision, acoustic, and location, chemical and biological sensors, mass spectrometry, thermal, magnetic sensors gas detection, RF, LIDAR, RADAR.

The user interface and experience are the final conceptual layer for purposes disclosed herein but note that other conceptual layers may be implemented thereon if needed, where the differentiation between the lower level in the technology stack is the addition of the policy engine, mobile platforms, and other embodiments which create the CPS. The CPS can now monitor their critical assets and intrusions in a more intuitive three-dimensional way and continue doing so for longer time with less people as the system creates, deploys or uses different algorithms to draw attention to the behaviors which may be of interest. In one embodiment, the CPS may generate a heatmap of any elements which are deemed to be of importance as set forth in the policy engine. The use of these systems with these methods described in this disclosure enables a more intuitive understanding of the environment and a less lethal approach to physical security protection and may be implemented in a variety of embodiments.

### BRIEF DESCRIPTION OF DRAWINGS

The present disclosure is further described in detail below with reference to the accompanying drawings and specific embodiments in which references indicate similar elements.

FIG. 1 illustrates an overview of the active denial system as embodied in one configuration according to this disclosure. This system is a system of systems which prevents, reduces or minimizes unauthorized or unlawful behavior.

FIG. 2 illustrates an embodiment of the manual workflow of a system in use by a security professional according to this disclosure.

FIG. 3 illustrates an embodiment of the User Interface (UI) and User Experience (UX) of the active denial system, and different elements a system may use according to this disclosure.

FIG. 4 illustrates an embodiment of the feature detection used to analyze scenes and determine threat levels and courses of actions and responses both human and direct energy, whether it be through classical elements or through machine learning according to this disclosure.

FIG. 5 illustrates an embodiment of the layer of the technical stack where different embodiments of non-lethal and less than lethal technologies exist according to this disclosure.

FIG. 6 illustrates an embodiment of the mobile platforms which can optionally be used by an active denial system according to this disclosure.

FIG. 7 illustrates an embodiment of the use of virtual and off-site or onsite remote monitoring or active monitoring of both the areas of protection and the management of the fleet according to this disclosure.

FIG. 8 illustrates an embodiment of the layer where the policy and rules of engagement are met and coded into the active denial in order to reduce liability according to this disclosure.

FIG. 9 illustrates an embodiment of the systems in place which take many of the day-to-day tasks and simplify them so that security professionals can focus on protection according to this disclosure.

FIG. 10 illustrates an embodiment of the system considering the physical geometry and infrastructure of an area with an active denial system according to this disclosure.

FIG. 11 illustrates an embodiment of the cloud and on premises computing infrastructure which balances latency, information, and point of need data according to this disclosure.

FIG. 12 represents an embodiment of the current security infrastructure, including Fire and EMS according to this disclosure. The security infrastructure is made of physical devices, sensors, locks, alarms and the like.

FIG. 13 illustrates an embodiment of the physical infrastructure which an active denial system sits upon, this could include electricity, gas, water, data, and buildings according to this disclosure.

FIG. 14 illustrates an embodiment of a computing environment that can execute active denial system according to this disclosure.

### DETAILED DESCRIPTION

This disclosure is now described more fully with reference to various figures that are referenced above, in which some embodiments of this disclosure are shown. This disclosure may, however, be embodied in many different forms and should not be construed as necessarily being limited to only embodiments disclosed herein. Rather, these embodiments are provided so that this disclosure is thorough and complete, and fully conveys various concepts of this disclosure to skilled artisans.

Various terminology used herein can imply direct or indirect, full or partial, temporary or permanent, action or inaction. For example, when an element is referred to as being “on,” “connected” or “coupled” to another element, then the element can be directly on, connected or coupled to the other element or intervening elements can be present, including indirect or direct variants. In contrast, when an element is referred to as being “directly connected” or “directly coupled” to another element, there are no intervening elements present.

Likewise, as used herein, a term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

Similarly, as used herein, various singular forms “a,” “an” and “the” are intended to include various plural forms (e.g., two, three, four) as well, unless context clearly indicates otherwise. For example, a term “a” or “an” shall mean “one or more,” even though a phrase “one or more” is also used herein.

Moreover, terms “comprises,” “includes” or “comprising,” “including” when used in this specification, specify a presence of stated features, integers, steps, operations, elements, or components, but do not preclude a presence and/or addition of one or more other features, integers, steps, operations, elements, components, or groups thereof. Furthermore, when this disclosure states that something is “based on” something else, then such statement refers to a basis which may be based on one or more other things as well. In other words, unless expressly indicated otherwise, as used herein “based on” inclusively means “based at least in part on” or “based at least partially on.”

Additionally, although terms first, second, and others can be used herein to describe various elements, components, regions, layers, subsets, diagrams, or sections, these elements, components, regions, layers, subsets, diagrams, or sections should not necessarily be limited by such terms. Rather, these terms are used to distinguish one element, component, region, layer, subset, diagram, or section from another element, component, region, layer, subset, diagram, or section. As such, a first element, component, region, layer, subset, diagram, or section discussed below could be termed a second element, component, region, layer, subset, diagram, or section without departing from this disclosure.

Also, unless otherwise defined, all terms (including technical and scientific terms) used herein have the same meaning as commonly understood by one of ordinary skill in an art to which this disclosure belongs. As such, terms, such as those defined in commonly used dictionaries, should be interpreted as having a meaning that is consistent with their meaning in a context of a relevant art and should not be interpreted in an idealized or overly formal sense unless expressly so defined herein.

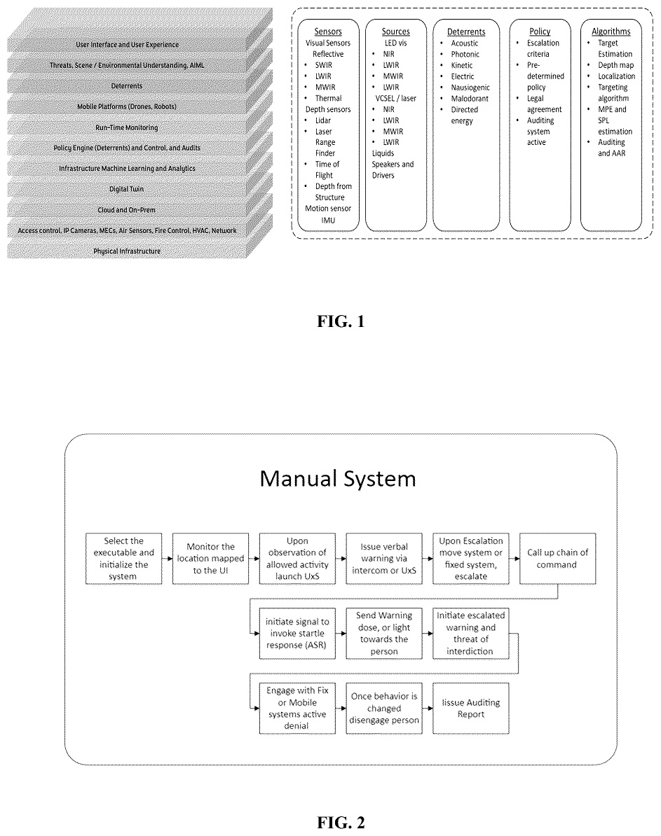

FIG. 1 illustrates the methods the systems which can be used to safely identify targets, track them, show them visually in a space, integrate with current security infrastructure, and interdict with a variety of non-lethal and less than lethal technologies of which there are many embodiments. Some embodiments of this disclosure use non-lethal and less than lethal technologies countermeasures, not the type of non-lethal and less than lethal technologies being used conventionally, although this is possible. In this drawing, there are depicted many but not explicitly all the types of sensors, sources, deterrents, policy, and algorithms desired to create an efficacious system. The numerous conceptual layers depicted in the illustration are outlined below. The lists to the right of the technology stack are different aspects of an active denial system which may be used. The primary components of a Counter Personnel System (CPS) will include many elements all with the intent of preventing people from entering a protected space or in some instances changing the behavior of personnel in a controlled space. The primary system is a coordination of many technologies that on their own may not reach the outcome of counter personnel.

FIG. 2 illustrates an embodiment of a method of operation of an Active denial system when used in many different systems configurations as shown but not exclusive to in FIG. 1. The embodied process is shown as one of many Standard Operating Procedures (SOP)s that a security company or monitoring company and or end user may use to engage and end an active denial system. Once the User authenticates into the security program and launches the User Interface (UI), the User can begin to manually operate the UI to scan an area or series of areas for any behavior which is not permitted (e.g., by law, internal policies). An observation of a behavior that is not authorized by as an example, the security professional may result in an issuance of a verbal warning via intercom or audio broadcast system or through the UX S system that is a UAS or a UGS or a fixed intercom system. If the interloper's behavior does not change, then the next level of escalation is permitted and at the same time a chain of command call is prompted on the UI. If the behavior continues, then the User may issue a warning via non-lethal mechanism whether it be a startle response from an audio or acoustic source, a laser dazzler warning, a thermal or RF source which elicits dermal agitation or any other non-lethal and less than lethal technologies mechanism or embodiment. In this embodiment, the security professional may issue one final warning (e.g., via intercom or through the UX S system that is a UAS or a UGS or a fixed intercom system) and if the behavior is not changed, then the system will become fully armed and repel the interloper through active denial. At the end of the incident an automated audit report is issued and sent up the chain of command and to legal (by electronic communications such as email).

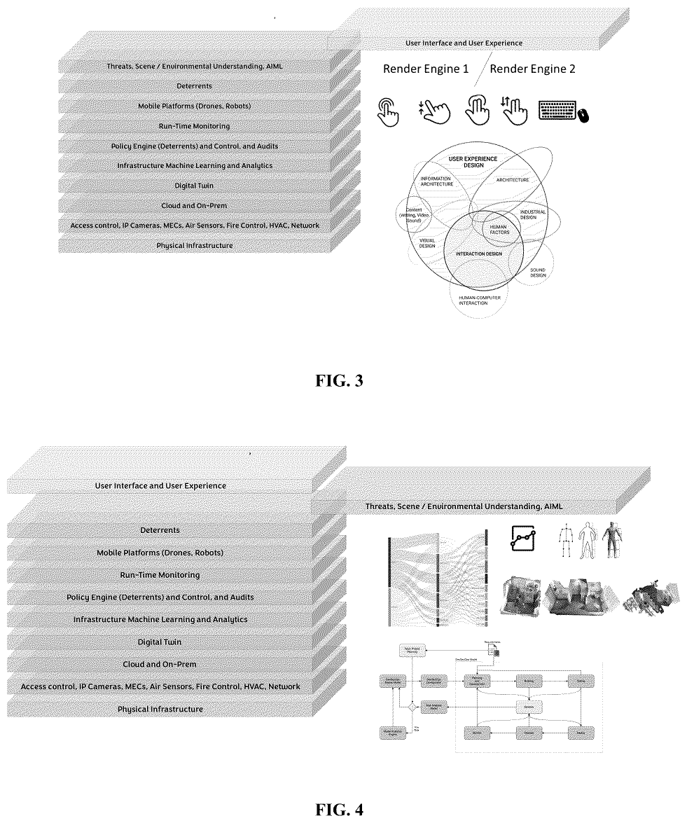

FIG. 3 illustrates an embodiment of a technology stack to build a fully operational for purposes disclosed herein and conceptual layers may be used; the top layer is the user interface which also includes the user experience of the active denial system. In this embodiment, it is possible to use any render engine (e.g., a task-dedicated executable logic that can be started, stopped, or paused) to generate a low latency, easy to use system. Examples of render engines are Unity or Unreal which are commercially available and heavily used. Within the user interface, a combination of different embodiments may be used to provide a user experience that has low cognitive load and is easy for a security professional with little training to use. The user interface has multiple elements chosen purposefully to reduce the cognitive load to accomplish. A key element of the User interface is the representation of assets as observed in a scene dynamically. The 3D properties of the User Interface stand in contrast to the screens displayed by current Video Management Systems (VMS) in which each camera is displayed in an array across the field of view of the security professional.

FIG. 4 illustrates the targeting and scene understanding AI/ML used in an active denial system. Historically, most AI/ML applications are used in the security industry to analyze scenes that have already happened in one embodiment. They are observers but have no method to repel people as part of a CPS. Described here, one may use a variety of algorithms to accomplish many scene analysis operations. An example of such algorithms but not exclusive to these are, pose detection, eye position and gaze, behavior analysis, scene reconstruction, semantic scene description, and others. One embodiment would be a segmentation algorithm built through various Convolution Neural Networks (CNNs) and trained with supervised data. In this approach, a large amount of videos of a large range of scenarios is captured and manually labeled and a standard CNN is built to label and segment a scene. More modern approaches, such as attention auto-encoders, can be used to look for anomaly detection of a given scene. A Counter Personnel System (CPS) can implement algorithms to detect different features, target different personnel, and track them across many scenarios. One implementation will include a person detector, a person counter, a person targeting system, and an autonomous navigation system.

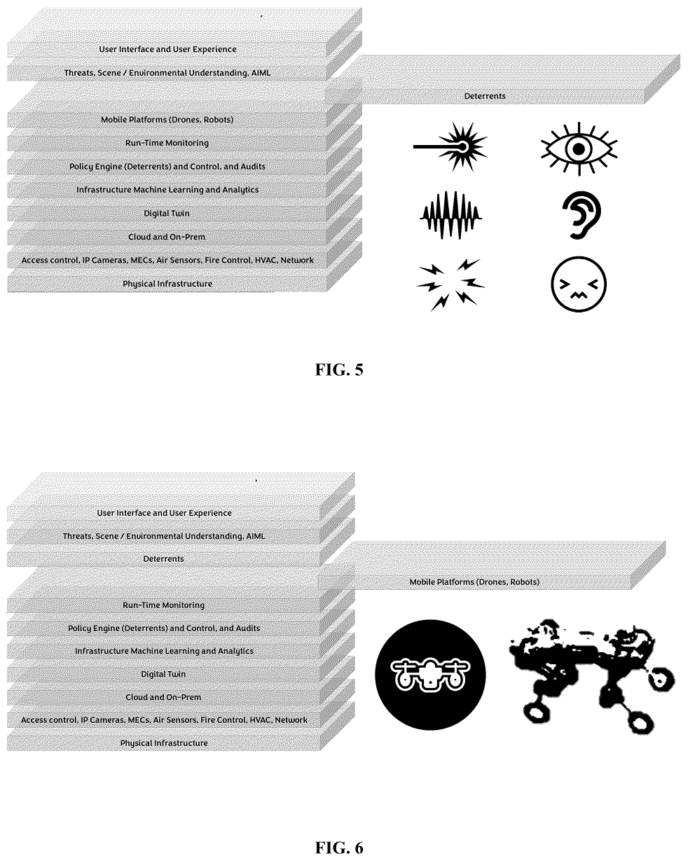

FIG. 5 illustrates the non-lethal and less than lethal technologies deterrents used by the Counter Personnel System. These deterrents are meant to interface with the human body through the senses and generate a parasympathetic response in the cognitive system, resulting in a “flight” reaction. One embodiment of the system is acoustic, whether by magnitude, frequency, direction, distributed source, or source sound which will interact with the hearing sense and the feeling sense in the form of pressure for acoustic sounds within a range or varying within a range between about 140 dB and about 1000 dB, for example, although lower upper bounds are possible, such as 900, 800, 600, 500, 400, 300, 200, 150 dB, or others, +/−10%. In addition to this embodiment, or in another embodiment, a photonic device may be used to obscure the vision of an individual and cause them to decrease their accuracy in their unauthorized task. An example of such a device is a laser source, which when coupled with a steering mirror may be able to reach many field points across the active denial systems field of view. In this embodiment or in another embodiment, it may be possible to use other technologies, such as Malodorant, laser ablation, pressure, kinetic systems among others.

FIG. 6 illustrates the next layer of the CPS technology stack; this is the possibility of mobile platforms in many embodiments of an active denial system. These mobile platforms can include any format, configuration, system, or method to move a deterrent as described in FIG. 5. Examples of these technologies include Unmanned Aerial Systems (UAS), e.g., a fixed wing, single rotor, multi-motor or any other UAS. Another embodiment or method will include Unmanned Ground System (UGS), e.g., one to many wheeled, tracked, bi to multiple legged walking robots. In some embodiments this can include manned vehicles of both air and ground. These mobile platforms are an extension of the previously disclosed fixed platforms. Note that marine vehicles (e.g., boats) are possible as well. These mobile platforms are used to carry the non-lethal and less than lethal technologies deterrents to create the maximum effect of as part of a CPS.

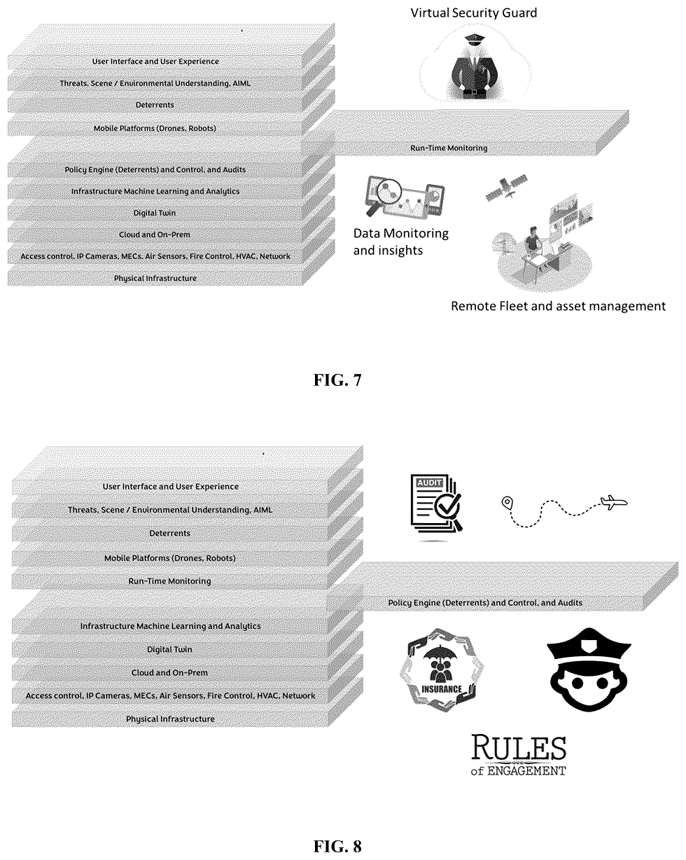

FIG. 7 illustrates the layer of the active denial system which integrates with current Virtual Management Systems (VMS) where remote security professionals monitor a location while not being physically onsite. The system may have different companies monitor, or the same company.

The key element is the remote monitoring. The VMS system or onsite local system may remotely monitor the security infrastructure, capture and analyze data, and conduct methods of fleet management. The CPS is a plugin or feature or may in some embodiments be the primary driver of the security solution deployed at a facility.

FIG. 8 illustrates a system which may, but is not, be required to analyze a scene a priori and determine the areas of interest to protect, reduce liability, or escalate to the next level of interdiction. The purpose of the work is to allow for lawyers and insurance underwriters to sign off on a Rule of Engagement (ROE) and establish a training protocol where the security professional may benefit. This system can actively be programmed into the active denial system creating a software defined policy procedure for active denial. This will limit the actions of a security professional to the levels agreed upon a priori. A software defined 3D policy engine is a system for which the geometric and feature based components of a scene can be assigned to specific policies dictated by the leadership of a site. An example of such a system may in one embodiment include a policy which says a person must be prevented from entering a specific geometric boundary without warning, so the policy engine would define a warning to be issued before a person is able to cross a geometric boundary of the CPS.

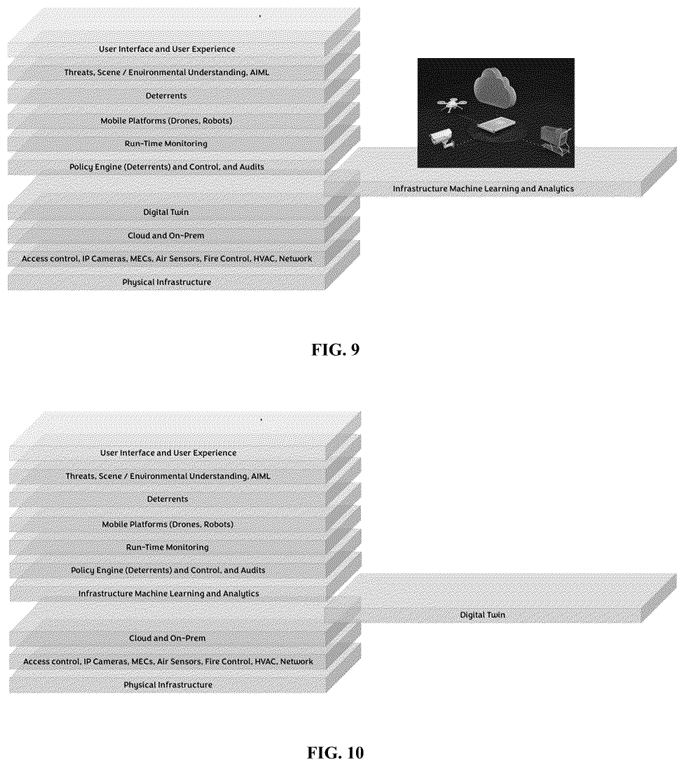

FIG. 9 illustrates the infrastructure Artificial Intelligence, Deep Learning, and Machine Learning layer of the CPS technology stack. In this embodiment, a series of algorithms may but are not required to be used to simplify tasks which can be modeled by algorithms. An embodiment of an algorithm used in the UI, is making decisions based on the behavior of the people in the environment observed. For example, if an algorithm may be used to look for behavior that indicates multiple people have identified a danger in their environment. This behavior in one embodiment can be characterized by segmenting all people in a scene and using the pose estimate of each person find one person is stationary and multiple people are backing up facing that stationary person in all directions. The CPS will then assign a probable threat label to the scenario and upon the value crossing a threshold of intensity will alert the security professional and warn the intruder at the same time.

FIG. 10 illustrates a digital twin in one embodiment of the CPS can be created a priori in order to better understand the scene in which a security system is monitoring. The increase of understanding is implemented by mapping the coverage of security cameras and other geometric features of the scene. This digital twin is a replica of a location and the infrastructure within. For example, IBM defines a digital twin as, “A digital twin is a virtual representation of an object or system that spans its lifecycle, is updated from real-time data, and uses simulation, machine learning and reasoning to help decision making.” Having a digital twin reduces the response time of a Counter Personnel System (CPS) and increases speed to repel intruders from a facility. In some embodiments, the digital twin may be at the center of the unlocking decreased cognitive load and reducing cost in training, resource usage, and overall manpower by creating the environment where machine learning and other computational methods can use elements of the digital twin to improve decision making with high probabilities of confidence. The Digital twin may be a key component of the system which is used for sentimental scene analysis.

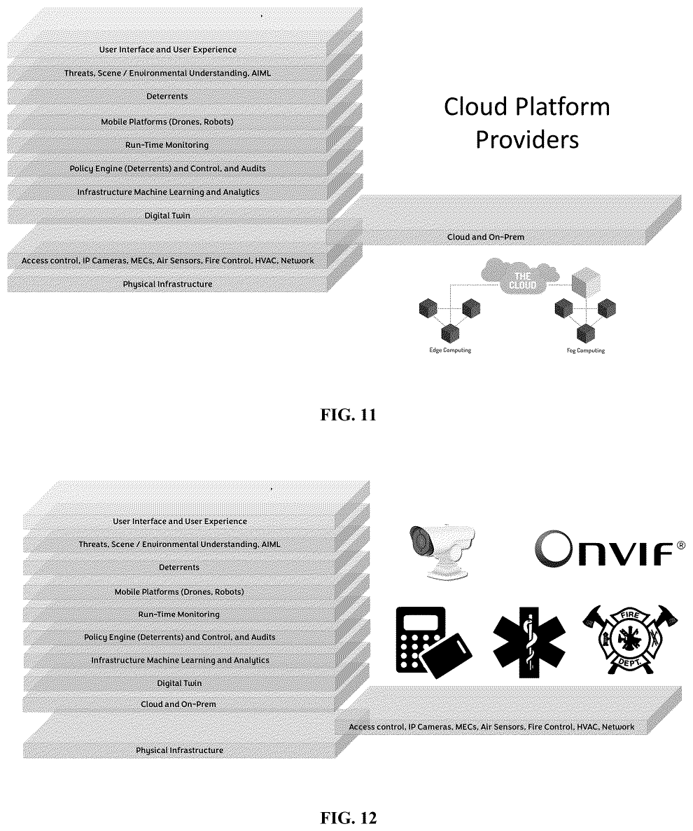

FIG. 11 illustrates how the CPS technology stack will have components which are maintained on premises or with different cloud providers. In one embodiment the storage of all previous data is maintained in a cloud service while real time information is processed and maintained onsite in servers which allow for lower latency. The system has in some embodiments high needs for computing, and this modality of operation can entail a distribution of computational, storage, and communications resources of which the layer of the stack is meant to interact.

FIG. 12 illustrates a series of integrations which may be performed to transition security professionals to the 3-dimensional way of thinking. This list of security professionals includes front line workers such as Police, Fire, and EMT. A technological benefit of using a 3-dimensional system is the ability to improve situational awareness of an event prior to arriving on the scene. The security system layers and other sensors are used to understand many of the currently used tools in the physical security and facilities arena. These tools can include interfacing with fire and rescue through fire control and emergency systems and services. The sensors also monitor the building behavior by sensing and capture the raw data which will be used in the digital twin to create the computational model of a facility.

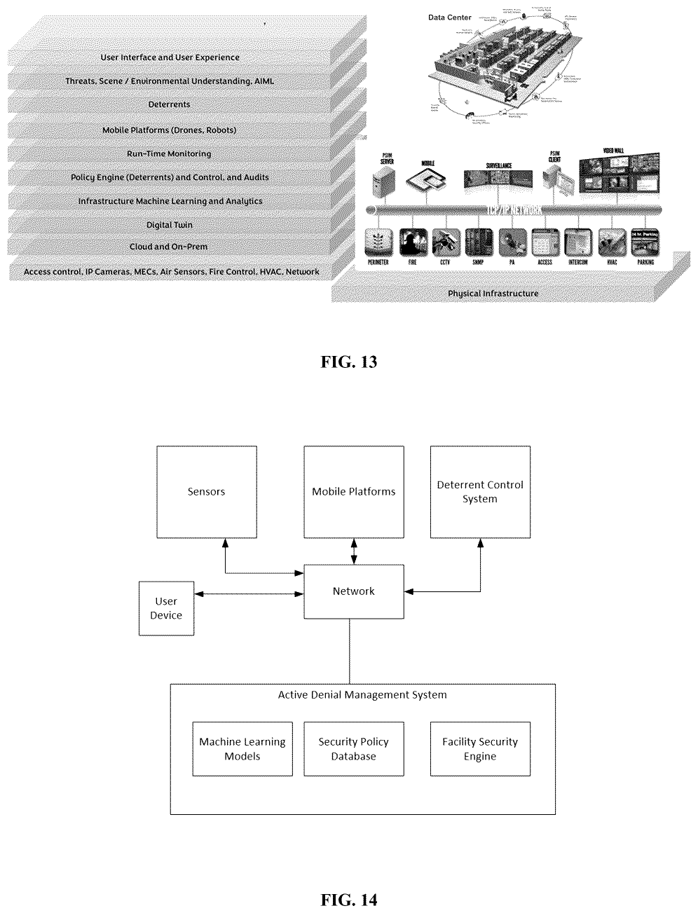

FIG. 13 illustrates infrastructure referring to the basic systems and services that an organization needs to function better than the status quo. For a whole, it includes all the physical systems such as the road and railway networks, utilities, sewage, water, telephone lines and cell towers, air control towers, bridges, etc., plus services including law enforcement, emergency services, healthcare, education, etc.

FIG. 14 illustrates a computing environment that can execute active denial system according to aspects of the present disclosure. For example, FIG. 14 depicts an active denial management system that is communicatively coupled (e.g., by wired or wireless networking infrastructure) to a network (e.g., a LAN, a WAN, a satellite network, a cellular network) to communicate with user devices, sensors, mobile platforms, and/or a deterrent control system. The network can be a physical network, a wireless communication network, or other suitable means of communication. In some examples, multiple networks may be used to communicate with each type of device (e.g., a first network for user devices, a second network for sensors, etc.). The active denial management system may include a machine learning model, a security policy database, and a facility security engine. Any of the machine learning model, security policy database (e.g., relational), or the facility security engine (e.g., a task-dedicated executable logic that can be started, stopped, or paused) may be executed as a logical component of the active denial management system or as a cloud-based or network-based component. The active denial management system is executable as a single computing device, or a distributed system across a network of computing devices. The machine learning models can perform operations as described above and can be convolutional neural networks, deep learning networks, generative-adversarial networks, or other machine learning models. The security policy database may include a predetermined set of policies, such as a set of conditions for activating the deterrent control system or components thereof. The security policy database may also include another set of conditions for activating or controlling the mobile platforms of the Counter Personnel System. For example, the security policy database may include a set of activities that are prohibited at the security facility. Each activity of the set of activities may be associated with an escalation process including a set of authorized deterrents and a sequence of the authorized deterrents. In some instances, the security policy database includes various sets of activities that if detected concurrently or within a time threshold have an additional authorization for deterrents. For example, a first activity has an associated low severity level and an authorized deterrent of a verbal warning via loudspeaker or other communication system. In another example, a combination of arson and brandishing or possessing a weapon may have a high severity level and an authorized deterrent of an agent such as a laser sparkle, acoustic deterrent, or a chemical agent. The security policy database may further include a time delay between authorized deterrents or escalating to an additional authorized deterrent for a prohibited activity that exceeds a threshold time.

The security policy database can be a relational database, an object storage architecture such as a data lake, or a non-relational database. The facility security engine may be an executable process that generates a digital representation of the facility including, but not limited to, structures, people, animals, vehicles, mobile platforms, gates, fences, sensors, and deterrent mechanisms and associated control devices. In some embodiments, the computing environment may include multiple user devices, such as for security personnel, facility management personnel, or other authorized users. The user devices may control or interact with the active denial management system using sets of permissions associated with different groups of users. For instance, the user devices may connect using a mobile application, biometric authentication, and/or the network. The active denial management system may control access or authentication of any user device to the network using encryption keys, virtual private network settings, token credentials, or other methods of controlling access of mobile devices to the network.

While various aspects and embodiments have been disclosed, other aspects and embodiments are contemplated. The various aspects and embodiments disclosed are for purposes of illustration and are not intended to be limiting, with the true scope and spirit being indicated by the claims in this application.

1. A method, comprising:
receiving, by a processing unit, a request to authenticate a user of an active denial management system from a computing terminal;
generating, by the processing unit, a scan result of a security facility after the request, wherein the scan result comprises a representation of a set of activities at a location of the security facility;
applying, by the processing unit, a machine learning model to the scan result such that the machine learning model determines whether the scan result includes at least one activity of the set of activities that is prohibited by a security policy set before the request is received;
performing, by the processing unit, based on the security policy and the at least one activity, an authorization of an activation of a deterrent control system that is expected to deter the at least one activity;
generating, by the processing unit, the authorization of the activation of the deterrent control system for the user;
taking, by the processing unit, an action based on the authorization.
